(19) United States
(12) Patent Application Publication
(10) Pub. No.: US 2006/0070489 A1
(43) Pub. Date: Apr. 6, 2006

(54) Bicycle pedal assembly

(76) Inventor: Chung-I Chen, Taichung Hsien (TW)

Correspondence Address: LADAS & PARRY LLP, 224 SOUTH MICHIGAN AVENUE, SUITE 1600, CHICAGO, IL, 60604, US

(21) Appl. No.: 10/952,993

(22) Filed: Sep. 29, 2004

(51) Int. Cl. G05G 1/14

(52) U.S. Cl. 74/594.6

(57) ABSTRACT

A bicycle pedal assembly includes a pair of front and rear biasing members for biasing a pair of front and rear clamping members to press a cleat against a pedal body unit. During assembly, the cleat is placed on the front and rear lamping members, and is pressed downwardly to rotate the front and rear clamping members against the biasing action of the front and rear biasing members.

### BACKGROUND OF THE INVENTION

1. Field of the Invention

This invention relates to a bicycle pedal assembly, and more particularly to a bicycle pedal assembly that includes a pair of front and rear clamping members, which are biased to press a cleat against a pedal body unit.

2. Description of the Related Art

A conventional pedal assembly for a racing bicycle typically includes a pedal body unit, a front retaining member fixed on the pedal body unit, a cleat disposed on the pedal body unit and having a front end inserted into a space between the front retaining member and the pedal body unit, and a rear clamping member biased by a spring to press a rear end of the cleat against the pedal body unit. The cleat is connected fixedly to a shoe of a cyclist. During assembly, the front end of the cleat is inserted into the space between the front retaining member and the pedal body unit. Subsequently, a rear end of the cleat is pressed downwardly to turn the rear clamping member rearwardly against the biasing action of the spring. When the rear end of the cleat contacts the pedal body unit, the rear clamping member is biased by the spring to return to its original position so as to confine the cleat among the pedal body unit, the front retaining member, and the rear clamping member. The conventional pedal assembly is disadvantageous in that the foot of the cyclist wearing the shoe is easy to hurt due to need of turning the cleat when the cleat is mounted to the pedal body unit.

### SUMMARY OF THE INVENTION

The object of this invention is to provide a safety bicycle pedal assembly that does not need turn a cleat when the cleat is mounted to a pedal body unit.

According to this invention, a bicycle pedal assembly includes a pair of front and rear biasing members for biasing a pair of front and rear clamping members to press a cleat against a pedal body. During assembly, the cleat is placed on the front and rear lamping members, and is pressed downwardly to rotate the front and rear clamping members against the biasing action of the front and rear biasing members.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of the preferred embodiment of a bicycle pedal assembly according to this invention;

FIG. 2 is an assembled perspective view of the preferred embodiment;

FIG. 3 is a schematic sectional side view of the preferred embodiment, illustrating how a cleat is mounted to a pedal body unit;

FIG. 4 is a schematic top view of the preferred embodiment, illustrating how the cleat is rotated on the pedal body when it is desired to remove the cleat from the pedal body;

FIG. 5 is a top view of the preferred embodiment, the cleat being removed for the sake of brevity; and

FIG. 6 is a schematic sectional side view of the preferred embodiment, illustrating how a shoe of a cyclist is placed on the pedal body unit and a pair of front and rear clamping members when the cleat is removed from the shoe.

### DETAILED DESCRIPTION OF THE PREFERRED EMBODIMENT

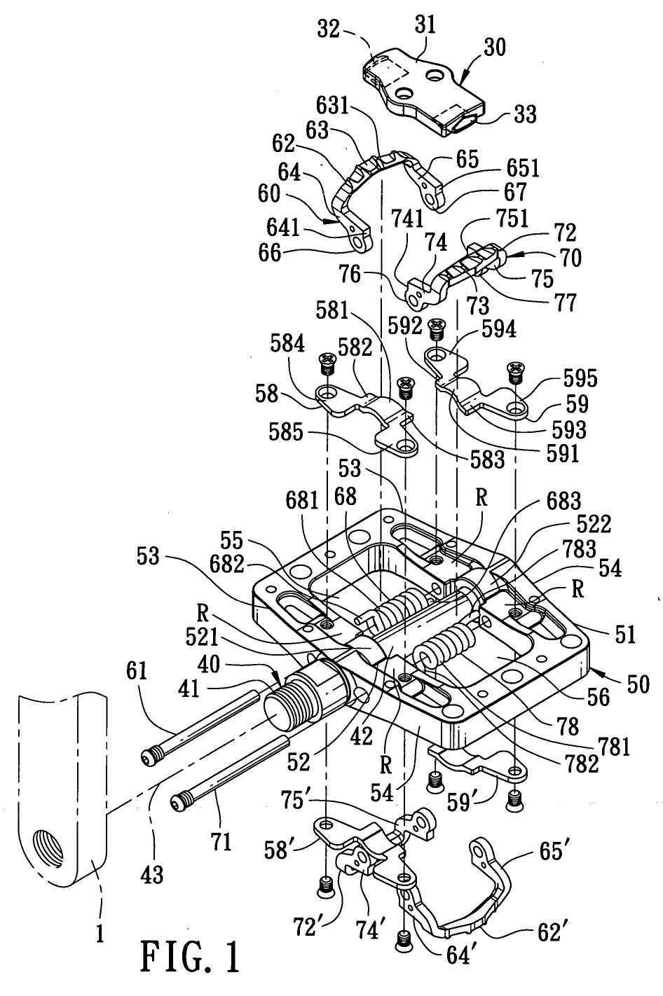

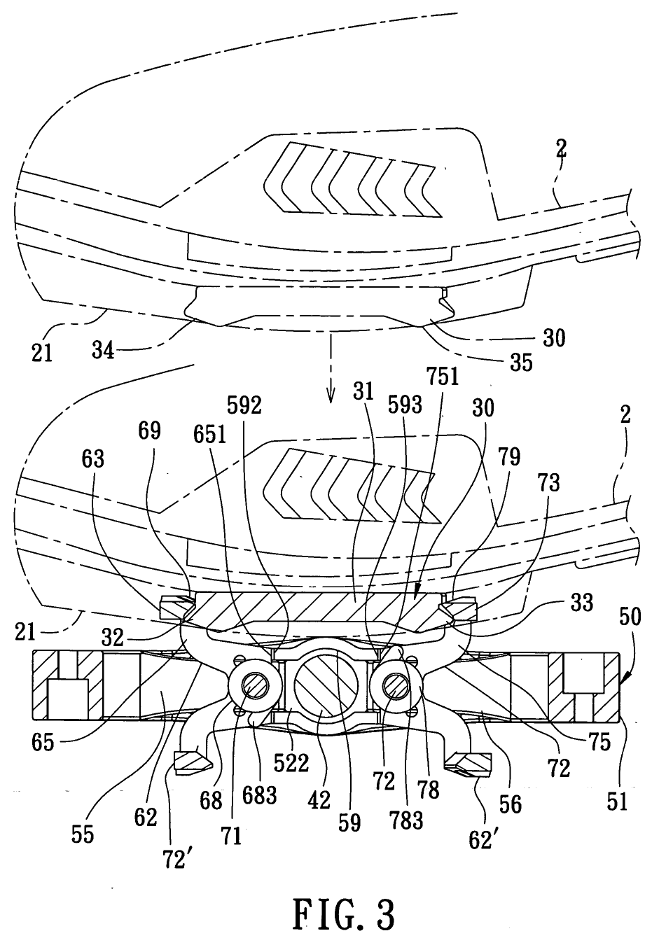

Referring to FIGS. 1, 2, and 3, the preferred embodiment of a bicycle pedal assembly according to this invention is shown to include a cleat 30, a pedal shaft 40, a pedal body unit 50, a front clamping unit 60, and a rear clamping unit 70. The cleat 30 is connected fixedly to a shoe 2 of a cyclist, and has a shoe-engaging portion 31, a front end engaging portion 32, a rear end engaging portion 33, and a bottom surface that is formed with a rearwardly and downwardly inclined front guiding surface portion 34 (see FIG. 3) at a front end thereof, and a frontwardly and downwardly inclined rear guiding surface portion 35 (see FIG. 3) at a rear end thereof. The pedal shaft 40 is connected fixedly to a pedal crank 1, and has an inner end portion 41, an outer end portion 42 opposite to the inner end portion 41, and a central axis 43.

The pedal body unit 50 includes a pedal body 51, an inner stop member 58, and an outer stop member 59.

The pedal body 51 includes a sleeve tube 52 sleeved rotatably on the outer end portion 42 of the pedal shaft 40 and rotatable about the central axis 43 of the pedal shaft 40. The sleeve tube 52 has an inner end portion 521 and an outer end portion 522. Two front wings 53 extend respectively and frontwardly from the inner and outer end portions 521, 522 of the sleeve tube 52 to define a front accommodating space 55 therebetween. Likewise, two rear wings 54 extend respectively and rearwardly from the inner and outer end portions 521, 522 of the sleeve tube 52 to define a rear accommodating space 56 therebetween. Each of the front and rear wings 53, 54 has a top surface that is formed with a recess (R) (see FIG. 1), which is adjacent to the sleeve tube 52. The inner and outer stop members 58, 59 are fixed on the pedal body 50. Each of the inner and outer stop members 58, 59 has a shoe-supporting portion 581, 591 that is disposed directly above the pedal shaft 40 and that supports a bottom surface 21 (see FIG. 3) of the shoe 2 thereon, a front stop portion 582, 592 extending from the shoe-supporting portion 581, 591 into the front accommodating space 55, and a rear stop portion 583, 593 extending from the shoe-supporting portion 581, 591 into the rear accommodating space 56. Each of the inner and outer stop members 58, 59 further has two mounting portions 584, 585, 594, 595 that are disposed respectively at front and rear ends thereof. The mounting portions 584, 585, 594, 595 are disposed respectively within the recesses (R), and are connected respectively and threadedly to the front and rear wings 53, 54.

The front clamping unit 60 includes a front pivot pin 61, a front clamping member 62, and a front biasing member 68.

The front pivot pin 61 extends through the front accommodating space 55 in the pedal body unit 50, and is parallel to the central axis 43 of the pedal shaft 40.

The front clamping member 62 is generally U-shaped, is sleeved rotatably on the front pivot pin 61, and has an elongated clamping portion 63, two connecting portions 64, 65 extending respectively from two ends of the clamping portion 63, and two mounting portions 66, 67 extending respectively and downwardly from the connecting portions 64, 65. The mounting portions 66, 67 are sleeved rotatably on the front pivot pin 61. The clamping portion 63 has a curved rear end surface 631. Each of the connecting portions 64, 65 has a stop portion 641, 651.

The front biasing member 68 is configured as a torsional spring, and has a coiled body 681 sleeved on the front pivot pin 61, a first end 682 inserted into the connecting portion 64, and a second end 683. The second end 683 is mounted in such a manner that the front biasing member 68 can bias the front clamping member 62 to rotate relative to the pedal body 51 so that the clamping portion 63 of the front clamping member 62 presses the front end engaging portion 32 of the cleat 30 against the pedal body 51. At this time, the stop portions 641, 651 of the front clamping member 62 abut respectively against the front stop portions 582, 592 of the inner and outer stop members 58, 59 so as to prevent further rotation of the front clamping member 62 about the front pivot pin 61. As such, the front clamping member 62 is positioned relative to the pedal body 51. Connection relating to the second end 683 of the front biasing member 68 will be described hereinafter.

The rear clamping unit 70 includes a rear pivot pin 71, a rear clamping member 72, and a rear biasing member 78.

The rear pivot pin 71 extends through the rear accommodating space 56 in the pedal body unit 50, and is parallel to the central axis 43 of the pedal shaft 40.

The rear clamping member 72 is generally U-shaped, is sleeved rotatably on the rear pivot pin 71, and has an elongated clamping portion 73, two connecting portions 74, 75 extending respectively from two ends of the clamping portion 73, and two mounting portions 76, 77 extending respectively and downwardly from the connecting portions 74, 75. The mounting portions 76, 77 are sleeved rotatably on the rear pivot pin 71. Each of the connecting portions 74, 75 has a stop portion 741, 751.

The rear biasing member 78 is configured as a torsional spring, and has a coiled body 781 sleeved on the rear pivot pin 71, a first end 782, and a second end 783 inserted into the connecting portion 75 of the rear clamping member 72. The first end 782 is mounted in such a manner that the rear biasing member 78 can bias the rear clamping member 72 to rotate relative to the pedal body 51 so that the clamping portion 73 of the rear clamping member 72 presses the rear end engaging portion 33 of the cleat 30 against the pedal body 51. At this time, the stop portions 741, 751 of the rear clamping member 72 abut respectively against the rear stop portions 583, 593 of the inner and outer stop members 58, 59 so as to prevent further rotation of the rear clamping member 72 about the rear pivot pin 71. As such, the rear clamping member 72 is positioned relative to the pedal body 51. Connection relating to the first end 782 of the rear biasing member 78 will be described hereinafter.

Referring to FIG. 3, the front clamping member 62 has a top surface that is formed with a rearwardly and downwardly inclined guiding surface portion 69 at a rear end thereof. The rear clamping member 72 has a top surface that is formed with a frontwardly and downwardly inclined guiding surface portion 79 at a front end thereof. The front and rear guiding surface portions 34, 35 of the cleat 30 cooperate with the guiding surface portions 69, 79 of the front and rear clamping members 62, 72 to constitute a guiding device.

When it is desired to mount the cleat 30 to the pedal body unit 50, the front and rear guiding surface portions 34, 35 of the cleat 30 are placed respectively on the guiding surface portions 69, 79 of the front and rear clamping members 62, 72. Subsequently, the cleat 30 is pressed downwardly so that the front and rear guiding surface portions 34, 35 of the cleat 30 move along the guiding surface portions 69, 79 of the front and rear clamping members 62, 72. As such, the front claming member 62 is turned frontwardly against the biasing action of the front biasing member 68, and the rear clamping member 72 is turned rearwardly against the biasing action of the rear biasing member 78. When the cleat 30 moves to a position such that the front and rear end engaging portions 32, 33 of the cleat 30 are located respectively below the clamping portions 63, 73 of the front and rear clamping members 62, 72, the front and rear clamping members 62, 72 are biased by the front and rear biasing members 68, 78 to return to their original positions. Because there is no need to turn the cleat 30, injury of the foot of the cyclist wearing the shoe 2 can be prevented.

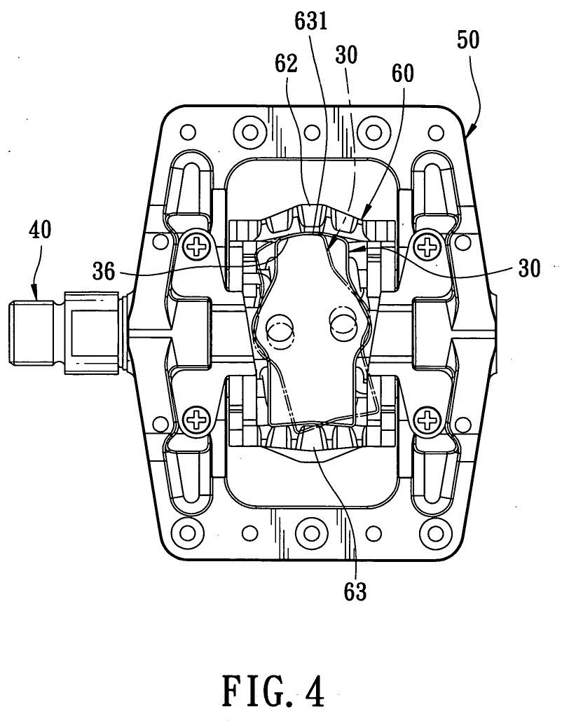

Referring to FIG. 4, when it is desired to remove the cleat 30 from the pedal body unit 50, the cleat 30 is turned in a known manner so as to move a curved edge 36 of the cleat 30 along the curved rear end surface 631 of the clamping portion 63 of the front clamping member 62. This will cause the front and rear clamping members 62,72 to turn away from each other so as to allow for removal of the cleat 30 from the pedal body unit 50.

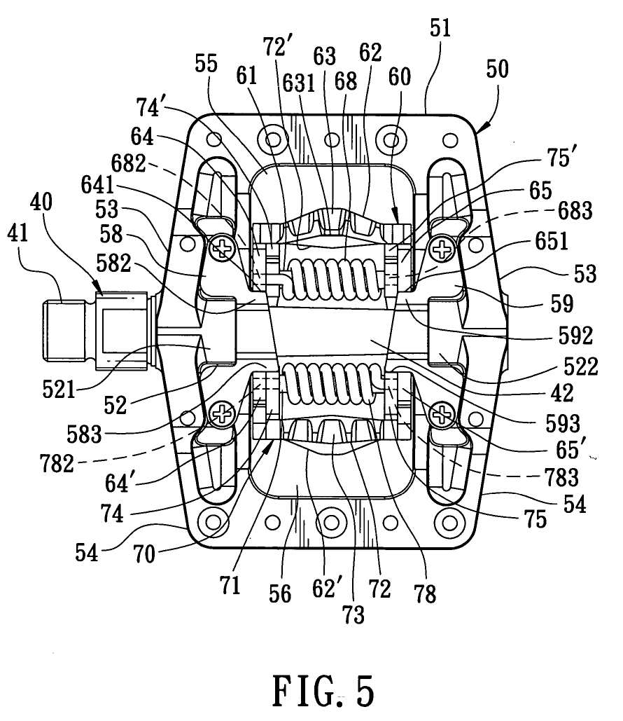

Referring to FIGS. 1, 2, 3, 5, and 6, bottom surfaces of the front and rear wings 53, 54 are provided with additional inner and outer stop members 58′, 59′ that are similar to the inner and outer clamping members 58, 59 in construction. Additional front and rear clamping members 62′, 72′ are disposed respectively within the rear and front accommodating spaces 56, 55, are sleeved respectively on the rear and front pivot pins 71, 61, and are similar to the front and rear clamping members 62, 72 in construction. The distance between the connecting portions 64, 65, 64′, 65′ of each of the front clamping members 62, 62′ are larger than that between the connecting portions 74, 75, 74′, 75′ of each of the rear clamping members 72, 72′. The first end 682 of the front biasing member 68 is inserted into the connecting portion 64 of the front clamping member 62, as described above. The second end 683 of the front biasing member 68 is inserted into the connecting portion 75′ of the rear clamping member 72′. The first end 782 of the rear biasing member 78 is inserted into the connecting portion 64′ of the front clamping member 62′. The second end 783 of the rear biasing member 78 is inserted into the connecting portion 75 of the rear clamping member 72. Thus, the cleat 30 can be clamped between the pedal body unit 50 and an assembly of the front and rear clamping members 62, 72 or between the pedal body unit 50 and an assembly of the front and rear clamping members 62′, 72′. As a consequence, the cleat 30 can be attached to either of two opposite sides of the pedal body unit 50.

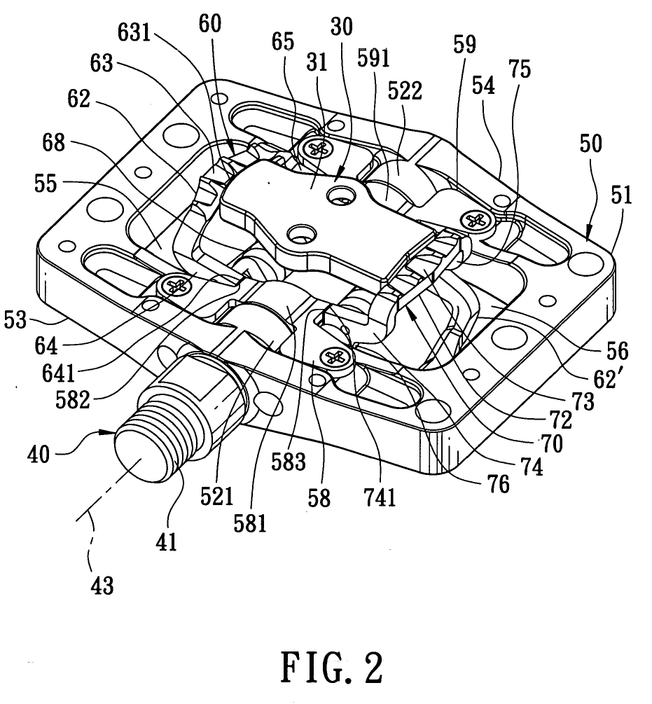

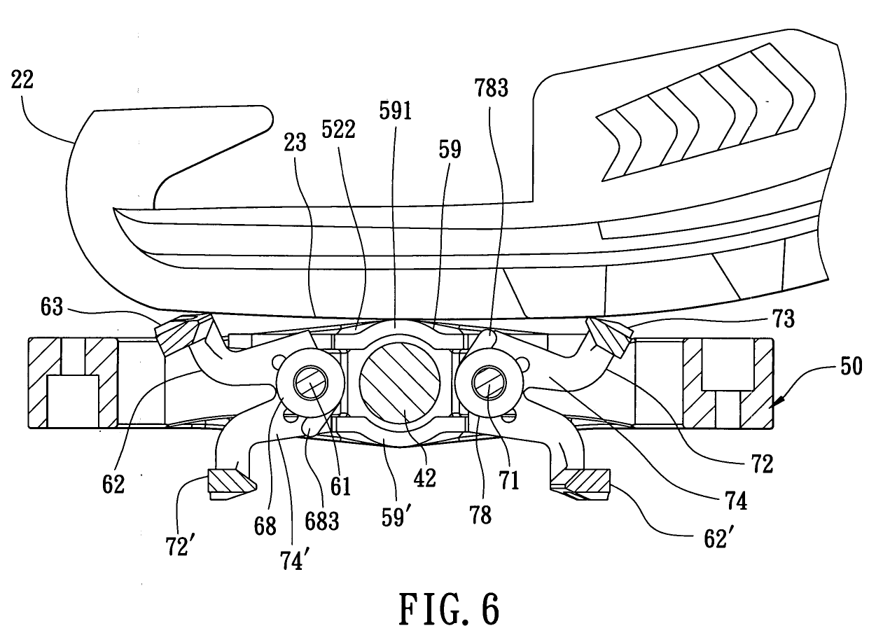

Referring to FIGS. 2 and 6, in case of a casual use of the racing bicycle, an uncleated shoe 22 can be placed directly on the pedal body unit 50 such that the front and rear clamping members 62, 73 are pressed to turn away from each other. Under this state, a bottom surface 23 of the shoe 22 is supported by the clamping portions 63, 73 of the front and rear clamping members 62, 72, the inner and outer end portions 521, 522 of the sleeve tube 52, and the shoe-supporting portions 581, 591 of the inner and outer stop members 58, 59.

With this invention thus explained, it is apparent that numerous modifications and variations can be made without departing from the scope and spirit of this invention. It is therefore intended that this invention be limited only as indicated by the appended claims.

I claim:

1. A bicycle pedal assembly comprising:
a pedal shaft having an inner end portion, an outer end portion opposite to said inner end portion, and a central axis;
a pedal body unit sleeved rotatably on said outer end portion of said pedal shaft and rotatable about said central axis of said pedal shaft;
a cleat adapted to be connected fixedly to a shoe of a cyclist and disposed on said pedal body unit, said cleat having front and rear end engaging portions;
a front clamping unit including a front clamping member disposed rotatably on said pedal body unit, and a front biasing member for biasing said front clamping member to rotate relative to said pedal body unit so as to press said front end engaging portion of said cleat against said pedal body unit;
a rear clamping unit including a rear clamping member disposed rotatably on said pedal body unit, and a rear biasing member for biasing said rear clamping member to rotate relative to said pedal body so as to press said rear end engaging portion of said cleat against said pedal body unit; and
a guiding device for guiding said cleat to move downwardly on said front and rear clamping members so as to turn said front and rear clamping members away from each other when said cleat is mounted to said pedal body unit.

2. The bicycle pedal assembly as claimed in claim 1, wherein said front clamping member has a top surface that is formed with a rearwardly and downwardly inclined guiding surface portion at a rear end thereof, said rear clamping member having a top surface that is formed with a frontwardly and downwardly inclined guiding surface portion at a front end thereof, said cleat having a bottom surface that is formed with a rearwardly and downwardly inclined front guiding surface portion at a front end thereof, and a frontwardly and downwardly rear guiding surface portion at a rear end thereof, said front and rear guiding surface portions of said cleat being placed respectively on said guiding surface portions of said front and rear clamping members and being pressed downwardly to move along said guiding surface portions of said front and rear clamping members when said cleat is mounted to said pedal body unit, said front and rear guiding surface portions of said cleat cooperating with said guiding surface portions of said front and rear clamping members to constitute said guiding device.

3. The bicycle pedal assembly as claimed in claim 1, wherein said pedal body unit includes:
a pedal body including
a sleeve tube sleeved rotatably on said outer end portion of said pedal shaft and rotatable about said central axis of said pedal shaft, said sleeve tube having an inner end portion and an outer end portion,
two front wings extending respectively and frontwardly from said inner and outer end portions of said sleeve tube to define a front accommodating space therebetween, and
two rear wings extending respectively and rearwardly from said inner and outer end portions of said sleeve tube to define a rear accommodating space therebetween; and
a pair of inner and outer stop members fixed on said pedal body, each of said inner and outer stop members having a shoe-supporting portion that is disposed directly above said pedal shaft and that is adapted to support the shoe of the cyclist thereon, a front stop portion extending from said shoe-supporting portion into said front accommodating space in said pedal body unit, and a rear stop portion extending from said shoe-supporting portion into said rear accommodating space in said pedal body unit;
wherein said front clamping unit further includes a front pivot pin extending through said front accommodating space in said pedal body unit and parallel to said central axis of said pedal shaft, said front biasing member being configured as a torsional spring and being sleeved on said front pivot pin, said front clamping member being sleeved rotatably on said front pivot pin and having an elongated clamping portion for pressing said cleat against said pedal body unit, and two stop portions biased by said front biasing member to press respectively against said front stop portions of said inner and outer stop members so as to prevent further rotation of said front clamping member about said front pivot pin; and
wherein said rear clamping unit further includes a rear pivot pin extending through said rear accommodating space in said pedal body unit and parallel to said central axis of said pedal shaft, said rear biasing member being configured as a torsional spring and being sleeved on said rear pivot pin, said rear clamping member being sleeved rotatably on said rear pivot pin and having an elongated clamping portion for pressing said cleat against said pedal body unit, and two stop portions biased by said rear biasing member to press respectively against said rear stop portions of said inner and outer stop members so as to prevent further rotation of said rear clamping member about said rear pivot pin.
